(19) United States
(12) Patent Application Publication
(10) Pub. No.: US 2017/0195817 A1
(43) Pub. Date: Jul. 6, 2017

(54) Simultaneous Binaural Presentation of Multiple Audio Streams

(71) Applicant: Knowles Electronics LLC, Itasca, IL (US)

(72) Inventor: Kuan-Chieh Yen, Foster City, CA (US)

(21) Appl. No.: 14/985,299

(22) Filed: Dec. 30, 2015

(51) Int. Cl. H04S 7/00; H04R 5/033; H04S 1/00; G06F 3/16

(52) U.S. Cl. CPC H04S 7/304; G06F 3/165; H04R 5/033; H04S 1/007; H04S 2420/01

(57) ABSTRACT

Systems and methods for simultaneous binaural presentation of multiple audio streams are provided. An example method includes receiving a first audio stream and at least one second audio stream. The first audio stream is associated with a first direction and the at least one second audio stream is associated with at least one second direction. The at least one second direction is set at an angle with respect to the first direction. A first acoustic sound is generated such that it may be perceived as the first audio stream coming from the first direction. An at least one second acoustic sound is generated such that it may be perceived as the at least one second audio stream coming from the at least one second direction. The first acoustic sound and the at least one second acoustic sound are blended into a third acoustic sound to be presented to a listener.

### FIELD

The present application relates generally to audio processing and, more specifically, to systems and methods for simultaneous binaural presentation of multiple audio streams.

### BACKGROUND

The use of headsets to consume music and other media content has gained popularity in recent years with the proliferation of applications utilizing mobile devices and cloud computing. In contrast to traditional telephony use where monaural headsets are typically sufficient, these applications often require stereo headsets for a full user experience. With the growth of the Internet-of-Things (IoT), the technical community also views a headset as a device where various types of sensors can collocate. As a result, ear-based wearables are typically viewed as a preferred option after wrist-based wearables.

For a headset to be an effective wearable device, it needs to be worn by a user over an extended period of time. However, a headset, especially a stereo headset, can often interfere with a user's sense of the surrounding audio scene. This interference may be inconvenient or even dangerous. As a result, ambient awareness has become an increasingly sought-after feature for smart stereo headsets. Ambient awareness refers to any technology that passes signals acquired by unobstructed microphones to a user's ears through a headset's loudspeakers. A simple example of ambient awareness technology includes sending an external microphone signal to a loudspeaker of a headset, either constantly or by user activation. A more sophisticated example of ambient awareness technology includes analyzing an audio scene and passing through only certain sounds to a user of a headset.

One of the drawbacks of a typical ambient awareness feature is that it may interfere with the headset user's primary activities, such as phone calls and music listening. Presenting separate audio streams simultaneously can be challenging. For example, mixing environmental sounds and speech during phone calls may reduce intelligibility of the speech.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Systems and methods for simultaneous binaural presentation of multiple audio streams are provided. The simultaneous binaural presentation of multiple audio streams according to various embodiments of the present disclosure, overcomes or substantially alleviates problems associated with distinguishing blended audio streams.

An example method includes receiving a first audio stream and at least one second audio stream. The example method associates the first audio stream with a first direction and the at least one second audio stream with at least one second direction. In various embodiments, the at least one second direction is set at a predetermined non-zero angle with respect to the first direction. The example method further includes generating, based on the first direction, a first acoustic sound. The first acoustic sound may be generated such that it is configured to be perceived as the first audio stream coming from the first direction. The example method also includes generating, based on the at least one second direction, at least one second acoustic sound. The at least one second acoustic sound may be generated such it is configured to be perceived as the at least one second audio stream coming from the at least one second direction. The example method proceeds to blend the first acoustic sound and the at least one further acoustic sound into a third acoustic sound to be played back to a listener. In some embodiments, the first audio stream includes music and/or speech.

According to example embodiments of the present disclosure, the steps of the method for simultaneous binaural presentation of multiple audio streams are stored on a non-transitory machine-readable medium comprising instructions, which, when implemented by one or more processors, perform the recited steps.

Other example embodiments of the disclosure and aspects will become apparent from the following description taken in conjunction with the following drawings.

### BRIEF DESCRIPTION OF THE DRAWINGS

Embodiments are illustrated by way of example and not limitation in the figures of the accompanying drawings, in which like references indicate similar elements.

FIG. 1 is a block diagram of a system and an environment in which systems and methods disclosed herein can be used.

FIG. 2 is a block diagram of a headset suitable for implementing the present technology, according to an example embodiment.

FIG. 3A is a block diagram illustrating perception of an audio stream by a listener, according to an example embodiment.

FIG. 3B is a block diagram illustrating perception of an audio stream and a further audio stream, according to an example embodiment.

FIG. 4 is a flow chart showing steps of a method for simultaneous binaural presentation of multiple audio streams, according to an example embodiment.

FIG. 5 illustrates an example of a computer system that may be used to implement embodiments of the disclosed technology.

### DETAILED DESCRIPTION

The present technology provides systems and methods for simultaneous binaural presentation of multiple audio streams, which can overcome or substantially alleviate problems associated with distinguishing blended audio streams. Embodiments of the present disclosure may allow for reducing interference between the blended audio streams while allowing listeners to focus on the audio stream of their choice. Exemplary embodiments make use of the fact that people discern sound sources from distinct physical locations better than sound sources in close proximity to each other. The present technology uses the binaural unmasking effect to improve signal intelligibility when an ambient awareness feature is activated. One of the uses of the present technology is when the ambient awareness feature is activated simultaneously with one or more additional applications where audio playback to the headset user is necessary. Examples of such applications include phone calls, music streaming, and newscast streaming. The present technology is also applicable when any combinations of these other applications are activated simultaneously.

Embodiments of the present technology may be practiced on any earpiece-based audio device that is configured to receive and/or provide audio such as, but not limited to, cellular phones, MP3 players, headsets, and phone handsets. While some embodiments of the present technology are described in reference to operation of a cellular phone, the present technology may be practiced on any audio device.

According to an example embodiment, the method for simultaneous binaural presentation of multiple audio streams includes receiving a first audio stream and at least one second audio stream. The example method includes associating the first audio stream with a first direction and the at least one second audio stream with at least one second direction. The at least one second direction may be set at a predetermined non-zero angle with respect to the first direction. The example method further includes generating, based on the first direction, a first acoustic sound. In various embodiments, the first acoustic sound is generated such that it can be perceived by a user as the first audio stream coming from the first direction. The example method also includes generating, based on the at least one second direction, at least one second acoustic sound. In various embodiments, the at least one second acoustic sound is generated such that it can be perceived by a user as the at least one second audio stream coming from the at least one second direction. The example method includes blending the first acoustic sound and the at least one second acoustic sound into a third acoustic sound to be played to a listener.

An audio stream refers to any audio signal to be presented to the headset user in any of these applications. Examples include: (1) received (far-end) signal of a phone call; (2) audio signal from media streaming, or a down-mixed version of it; (3) signals from ambience awareness microphones, or a down-mixed version; and (4) warning or notification sounds from smart phones. Various embodiments of the present technology present each of these diverse audio information at a distinct virtual location such that the user can digest this information with less effort. The present technology does not aim to present elements of the ambience awareness signals (the surrounding sounds) at their physical locations. Various embodiments of the present technology provide that, once a user identifies something interesting in the audio stream associated with ambience awareness, he/she can switch to exclusive ambience awareness mode to further observe the surrounding audio scene.

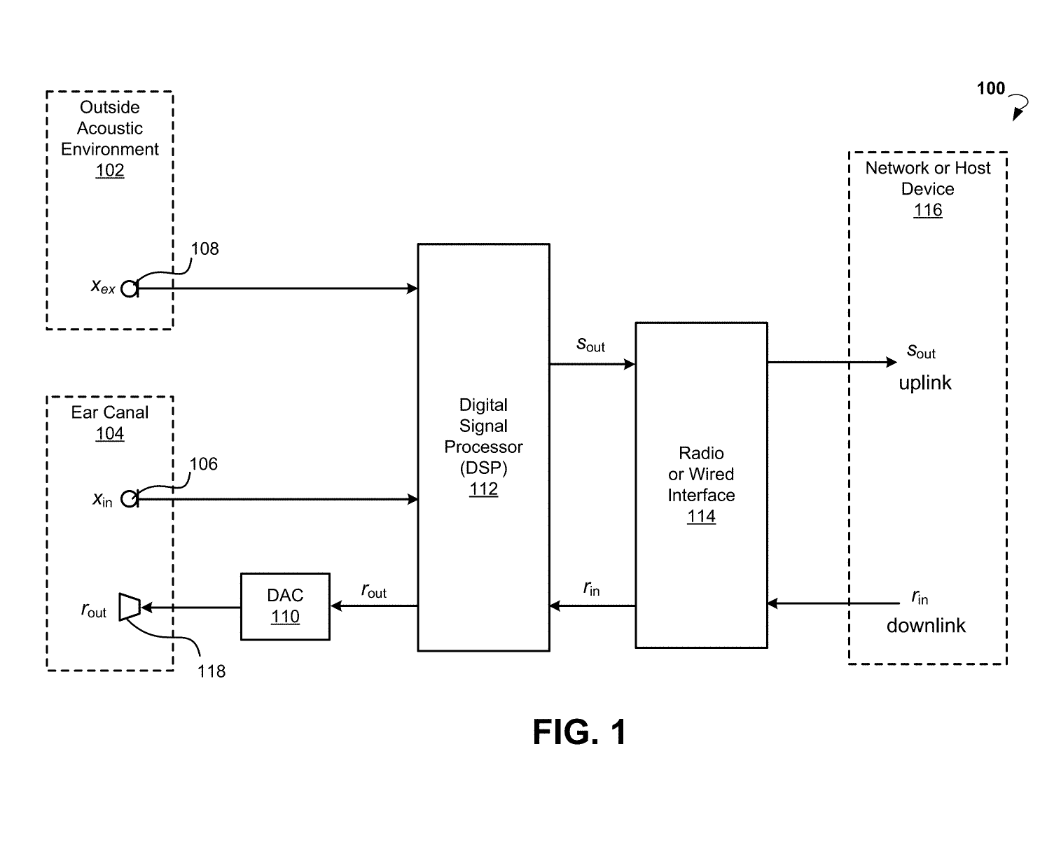

Referring now to FIG. 1, a block diagram of an example system 100 is shown, wherein the methods of the present disclosure can be practiced. The example system 100 can include at least an internal microphone 106, an external microphone 108, a digital signal processor (DSP) 112, and a radio or wired interface 114. The internal microphone 106 is located inside a user's ear canal 104 and is relatively shielded from the outside acoustic environment 102. The external microphone 108 is located outside the user's ear canal 104 and is exposed to the outside acoustic environment 102.

Two of the most important system components for some embodiments of the present technology are the two loudspeakers; one inside of a user's left ear canal and the other inside of the user's right ear canal. These loudspeakers may be used to present the blended binaural signal to the user. In some embodiments, it is possible to place loudspeakers at alternative locations, but at least two loudspeakers are necessary to create spatial perception, according to some embodiments.

In various embodiments, the microphones 106 and 108 are either analog or digital. In either case, the outputs from the microphones can be converted into synchronized pulse code modulation (PCM) format at a suitable sampling frequency and connected to the input port of the DSP 112. The signals xₑₓ (Left) and xₑₓ (Right) denote signals representing sounds captured by left and right external microphones 108, respectively

In some embodiments, only one external microphone 108 is needed for the ambience awareness feature. Two external microphones, one near the user's left ear and one near the user's right ear, may often be used to capture the binaural external sound field; however, alternative locations for the external microphones may be used for practicing the present technology. In some embodiments, more than two external microphones 108 are used to capture a more detailed external sound field for further sophisticated ambience awareness features.

On the right side of FIG. 1, sₒᵤₜ and rᵢₙ can be combined into a two-way signal flow labeled as “telephony”. In addition, a one-way signal flow from a network to the DSP may be added as “media streaming”.

In various embodiments, the DSP 112 processes and blends various audio streams and presents the blended binaural signal to the user through the headset loudspeakers. The inputs to the processing may include external microphone signals (ambience awareness), receive-in signals from phone calls, or streamed media contents (both from the radio or other wireless and wired interface 114). The output may be sent to the headset speakers 118.

A signal may be received by the network or host device 116 from a suitable source (e.g., via the radio or wired interface 114). This can be referred to as the receive-in signal (rᵢₙ) (identified as rᵢₙ downlink at the network or host device 116). The receive-in signal can be coupled via the radio or wired interface 114 to the DSP 112 for necessary processing. The resulting signal, referred to as the receive-out signal (rₒᵤₜ), can be converted into an analog signal through a digital-to-analog convertor (DAC) 110 and then connected to a loudspeaker 118 in order to be presented to the user. The loudspeaker 118 may be located in the same ear canal 104 as the internal microphone 106. In other embodiments, the loudspeaker 118 is located in the ear canal opposite the ear canal 104.

In some embodiments, the receive-in signal rᵢₙ includes an audio content for playing back to a user. The audio content can be stored on a host device or received by the network or host device 116 from a communication network.

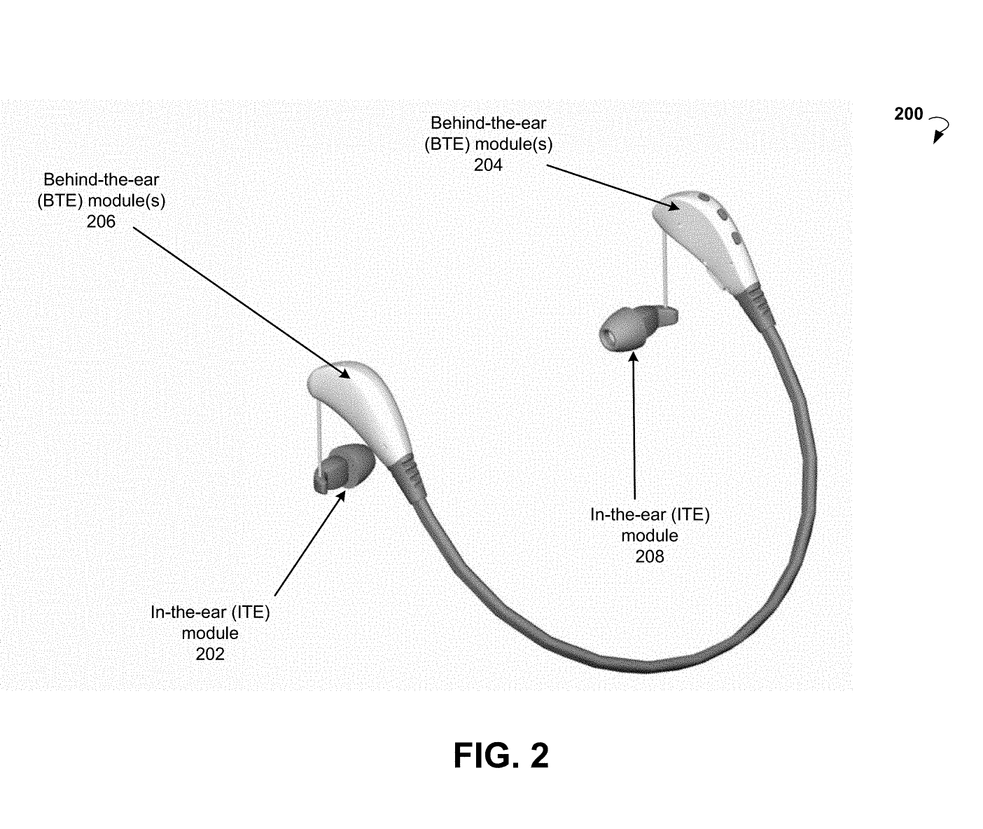

FIG. 2 shows an example headset 200 suitable for implementing methods of the present embodiments. The headset 200 can include example in-the-ear (ITE) modules 202 and 208 and behind-the-ear (BTE) modules 204 and 206 for each ear of a user. The ITE modules 202 and 208 can be configured to be inserted into the user's ear canals. The BTE modules 204 and 206 can be configured to be placed behind (or otherwise near) the user's ears. In some embodiments, the headset 200 communicates with host devices through a wireless radio link. The wireless radio link may conform to a Bluetooth Low Energy (BLE), other Bluetooth standard, 802.11, or other suitable wireless standard and may be variously encrypted for privacy.

In various embodiments, the ITE module(s) 202 include internal microphone(s) 106. Two loudspeakers 118 (one loudspeaker 118 in each ear canal) may be included, each facing inward with respect to a respective ear canal 104. In some embodiments, the ITE module 202 provides acoustic isolation between the ear canal 104 and the outside acoustic environment 102 (also shown in FIG. 1). Similarly, ITE module 208 includes an internal microphone and a loudspeaker and provides acoustic isolation of the ear canal opposite to ear canal 104.

In some embodiments, each of the BTE modules 204 and 206 includes at least one external microphone. The BTE module 204 may include a DSP, control button(s), and Bluetooth radio link to host devices. The BTE module 206 can include a suitable battery with charging circuitry.

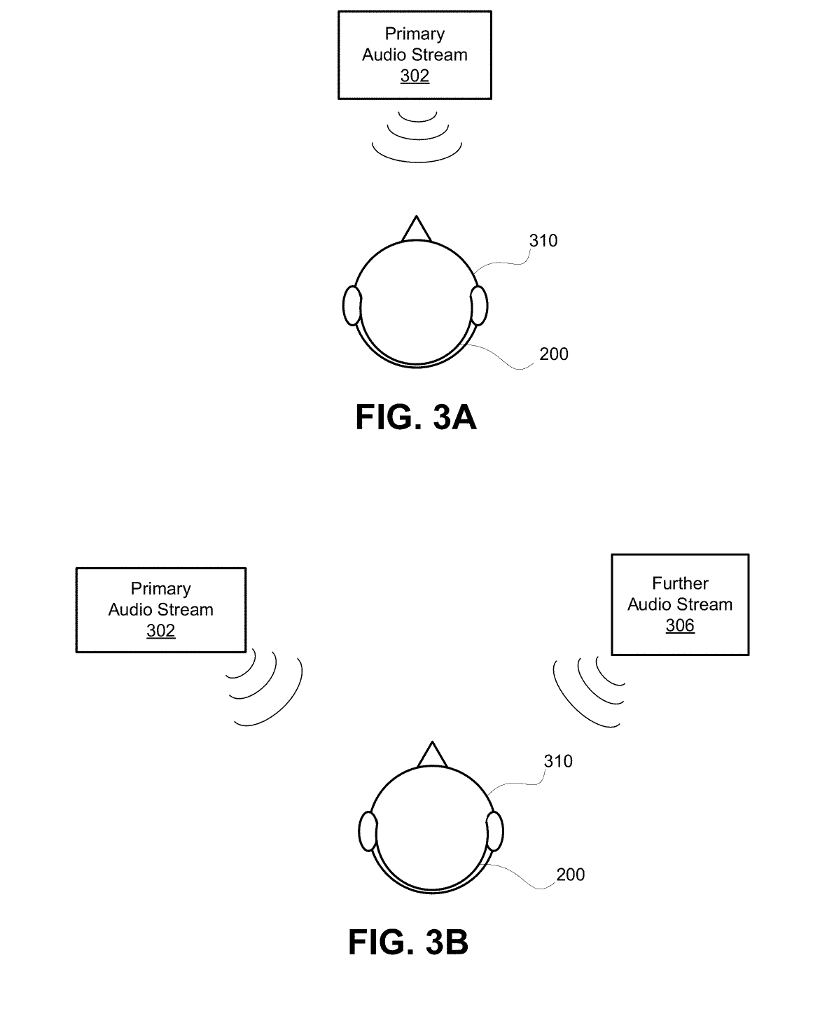

FIG. 3A is an example block diagram illustrating perception of an audio stream by a listener during regular operation of a headset. The audio stream (also referred to herein as primary audio stream or first audio stream) 302 is presented to a listener 310 by loudspeakers of headset 200. In some embodiments, the primary audio stream 302 includes an audio content (for example, music and speech) delivered to a listener via headset 200 from the network or host device 116 (as shown in FIG. 1). The primary audio stream 302 may include a monaural audio signal or a stereo audio signal.

In some embodiments, the regular operation of a headset might not be illustrated by FIG. 3A. The regular operation may depend on specific applications the headset is in: (1) For phone calls, the received signal tends to be monaural. If the signal is presented at both ears, it is often perceived as inside of the user's head. If it is only presented at only one ear, it would be perceived as around that ear. (2) For music streaming, the music content tends to be stereo. In this case, various vocals and instruments might be perceived as coming from different locations. (3) For ambience awareness, if the surrounding sound scene is presented, various sounds can also be perceived as coming from different locations. The audio contents of all these applications can occupy overlapping space. When they are presented simultaneously without alteration, they can interfere with each other and cause confusion to the user. Various embodiments of the present technology can resolve this confusion such that the user can digest these diverse information more easily.

In some embodiments, a further (second) audio stream 306 is blended with the primary (first) audio stream 302 to be presented to a listener 310. In other embodiments, the further (second) audio stream 306 includes an ambient pass-through signal. In certain embodiments, the ambient pass-through signal is generated based on signal xₑₓ captured by external microphones. In various embodiments, the ambient pass-through signal is blended with the primary signal in a way (described further herein) that is designed to draw the listener's attention to contents of the further (second) audio stream. The contents of the second audio stream may be, for example, a car horn, baby crying, phone ringing (e.g. ring tone), and so forth. A unique sound may be identified based on auditory scene analysis. An example system and method suitable for auditory scene analysis is discussed in more detail in U.S. patent application Ser. No. 14/335,850, entitled “Speech Signal Separation and Synthesis Based on Auditory Scene Analysis and Speech Modeling,” filed Jul. 18, 2014, the disclosure of which is incorporated herein by reference for all purposes.

An example system and method suitable for performing pass-through of ambient sounds is discussed in more detail in U.S. patent application Ser. No. ______, entitled “Voice-Enhanced Awareness Mode,” filed ______ 2015, the disclosure of which is incorporated herein by reference for all purposes.

In various embodiments, the further (second) audio stream includes a sound of a car horn, a sound of a baby crying, someone uttering the listener's name, a phone ringing, and so forth. In other embodiments, the further (second) audio stream 306 includes, for example, a warning voice message or a far end signal during a phone conversation (a phone call stream) coming from a device to which the headset 200 is coupled, for example, the network or host device to which the headset 200 is coupled. In some embodiments, there are multiple second audio streams.

In various embodiments, the primary audio stream 302, which may include music and/or speech, and the further audio stream 306 are separated. Hard panning is one known way for separating. In hard panning, for example, the primary audio stream 302 is panned to one ear of a listener 310 and the further audio stream is panned to the opposite ear of the listener 310. Both the primary audio stream 302 and the further audio stream 306 may be played as monaural signals. In this hard panning example, the separation of the signals does create some perceivable spatial separation such that the listener 310 might focus on either signal more easily, however, hard panning has at least one major drawback.

Hard-panning of the audio streams to opposite ears has the drawback of not sounding natural. In various embodiments, to mitigate this, binaural virtualization techniques are leveraged to provide a more natural spatial separation. Suitable head-related transfer functions (HRTFs) can be used to convert a monaural signal to a binaural (virtualization) signal that is perceived as coming from a specific direction. In certain embodiments, a first HRTF is associated with a first incoming direction and a further HRTF is associated with a further incoming direction. The further incoming direction may be set to differ from the first incoming direction by a particular angle. The first HRTF can be applied to the primary audio stream 302 and the further HRTF can be applied to the further audio stream 306 to create spatial separation.

In various embodiments, all of the audio streams are equally spaced in front of the user. For example, if there are four audio streams, they can be placed at 67.5° and 22.5° to the user's left, and 22.5° and 67.5° to the user's right, respectively. If the audio streams have different importance, the more important audio stream(s) can be placed at more central location(s), and/or separated by a larger angle away from other audio streams. Furthermore, stronger reverberation can be added to less important audio streams to highlight the more important audio streams.

Referring to FIG. 3B, various embodiments of the present technology may be used with the primary audio stream 302 and the further audio stream 306 being processed and presented to listener 310 by headset 200, such that the audio streams (the primary audio and further audio streams 302 and 306) would be perceived as originating from different directions. In further embodiments, a similar technology can be used to enable the simultaneous presentation of more than two audio streams.

In some embodiments, in addition to applying HRTFs, reverberation are added to each audio stream to create different depth perception. This may create further spatial contrast among different audio streams. The present technique may also be used to place differentiated emphasis on different audio streams.

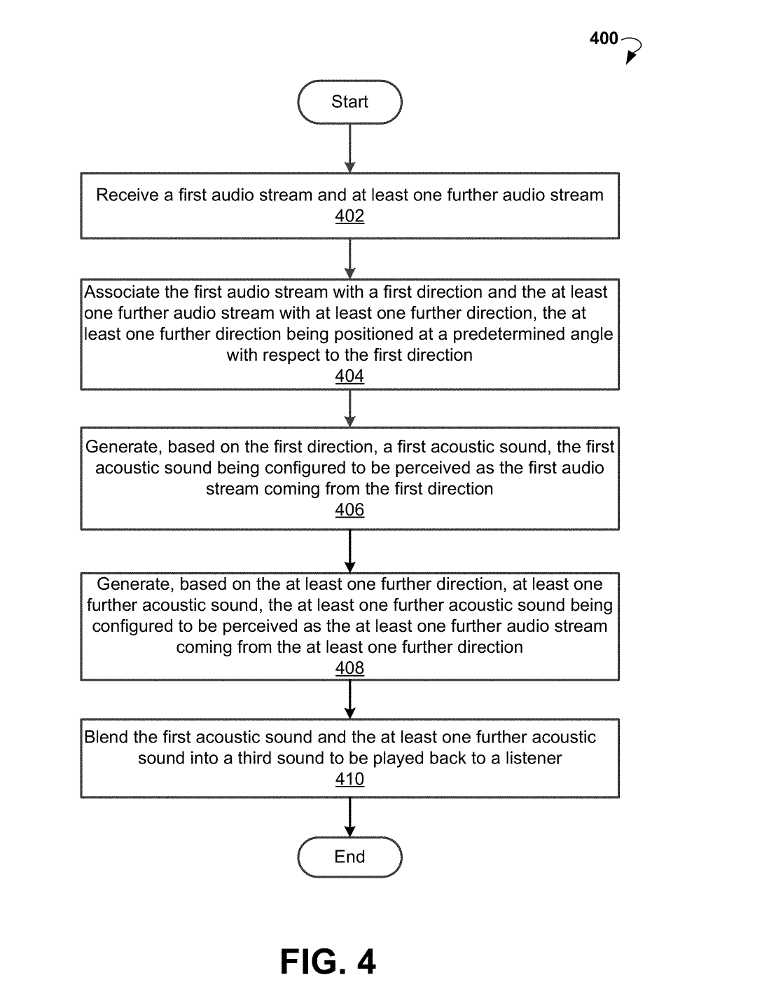

FIG. 4 is a flow chart showing steps of method 400 for simultaneous binaural presentation of multiple audio streams, according to some example embodiments. The example method 400 can commence with receiving a first audio stream and at least one further audio stream in block 402.

In block 404 in this example, the first audio stream is associated with a first direction and the at least one further audio stream is associated with a further direction. The at least one further direction may be positioned at a predetermined angle with respect to the first direction. In block 406, a first acoustic sound may be generated based on the first audio stream. In various embodiments, the first acoustic sound is generated such that it is configured to be perceived (by a user) as the first audio stream coming from the first direction.

In block 408, example method 400 proceeds with generating a further modified signal based on the at least one further acoustic sound. The at least one further acoustic sound may be generated based on the at least one further audio stream. In various embodiments, the at least one further acoustic sound is generated such that it is configured to be perceived (by a user), as the at least one further audio stream coming from the at least one further direction.

In block 410, the first acoustic sound and the at least one further acoustic sound can be blended into a third acoustic sound to be presented to a listener.

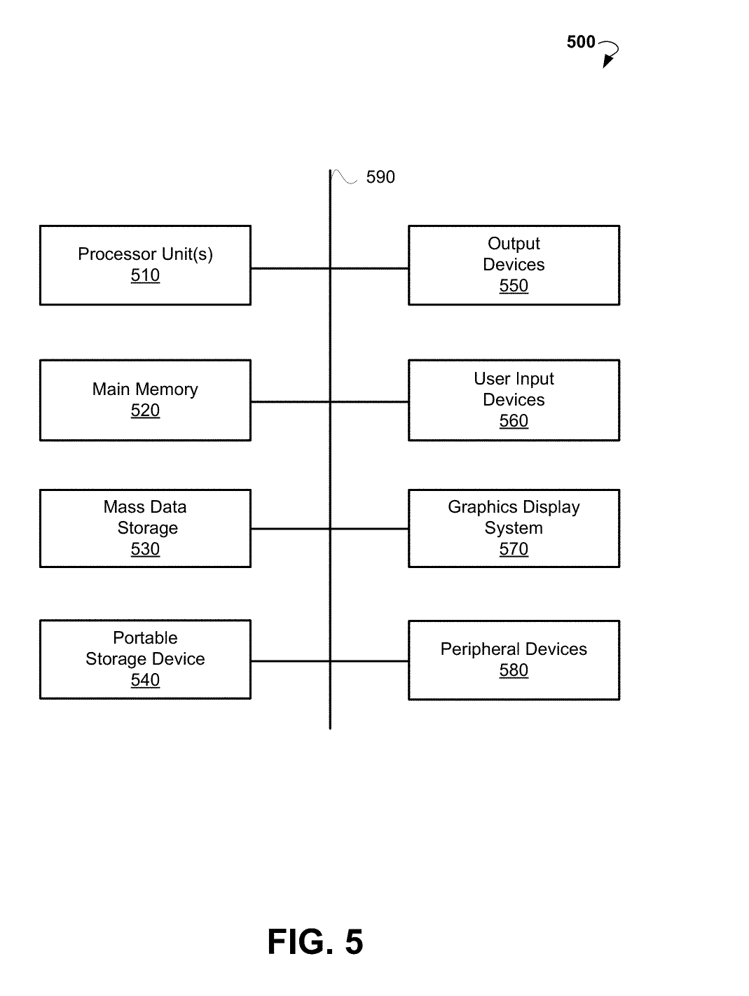

FIG. 5 illustrates an exemplary computer system 500 that may be used to implement some embodiments of the present invention. The computer system 500 of FIG. 5 may be implemented in the contexts of the likes of computing systems, networks, servers, or combinations thereof. The computer system 500 of FIG. 5 includes one or more processor units 510 and main memory 520. Main memory 520 stores, in part, instructions and data for execution by processor unit(s) 510. Main memory 520 stores the executable code when in operation, in this example. The computer system 500 of FIG. 5 further includes a mass data storage 530, portable storage device 540, output devices 550, user input devices 560, a graphics display system 570, and peripheral devices 580.

The components shown in FIG. 5 are depicted as being connected via a single bus 590. The components may be connected through one or more data transport means. Processor unit(s) 510 and main memory 520 is connected via a local microprocessor bus, and the mass data storage 530, peripheral device(s) 580, portable storage device 540, and graphics display system 570 are connected via one or more input/output (I/O) buses.

Mass data storage 530, which can be implemented with a magnetic disk drive, solid state drive, or an optical disk drive, is a non-volatile storage device for storing data and instructions for use by processor unit(s) 510. Mass data storage 530 stores the system software for implementing embodiments of the present disclosure for purposes of loading that software into main memory 520.

Portable storage device 540 operates in conjunction with a portable non-volatile storage medium, such as a flash drive, floppy disk, compact disk, digital video disc, or Universal Serial Bus (USB) storage device, to input and output data and code to and from the computer system 500 of FIG. 5. The system software for implementing embodiments of the present disclosure is stored on such a portable medium and input to the computer system 500 via the portable storage device 540.

User input devices 560 can provide a portion of a user interface. User input devices 560 may include one or more microphones, an alphanumeric keypad, such as a keyboard, for inputting alphanumeric and other information, or a pointing device, such as a mouse, a trackball, stylus, or cursor direction keys. User input devices 560 can also include a touchscreen. Additionally, the computer system 500 as shown in FIG. 5 includes output devices 550. Suitable output devices 550 include speakers, printers, network interfaces, and monitors.

Graphics display system 570 include a liquid crystal display (LCD) or other suitable display device. Graphics display system 570 is configurable to receive textual and graphical information and processes the information for output to the display device.

Peripheral devices 580 may include any type of computer support device to add additional functionality to the computer system.

The components provided in the computer system 500 of FIG. 5 are those typically found in computer systems that may be suitable for use with embodiments of the present disclosure and are intended to represent a broad category of such computer components that are well known in the art. Thus, the computer system 500 of FIG. 5 can be a personal computer (PC), hand held computer system, telephone, mobile computer system, workstation, tablet, phablet, mobile phone, server, minicomputer, mainframe computer, wearable, or any other computer system. The computer may also include different bus configurations, networked platforms, multi-processor platforms, and the like. Various operating systems may be used including UNIX, LINUX, WINDOWS, MAC OS, PALM OS, QNX ANDROID, IOS, CHROME, TIZEN, and other suitable operating systems.

The processing for various embodiments may be implemented in software that is cloud-based. In some embodiments, the computer system 500 is implemented as a cloud-based computing environment, such as a virtual machine operating within a computing cloud. In other embodiments, the computer system 500 may itself include a cloud-based computing environment, where the functionalities of the computer system 500 are executed in a distributed fashion. Thus, the computer system 500, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud may be formed, for example, by a network of web servers that comprise a plurality of computing devices, such as the computer system 500, with each server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depends on the type of business associated with the user.

The present technology is described above with reference to example embodiments. Therefore, other variations upon the example embodiments are intended to be covered by the present disclosure.

What is claimed is:

1. A method for binaural presentation of multiple audio streams, the method comprising:
receiving a first audio stream and at least one second audio stream;
associating the first audio stream with a first direction and the at least one second audio stream with at least one second direction, the at least one second direction being set at a predetermined non-zero angle with respect to the first direction;
generating, based on the first direction, a first acoustic sound configured to be perceived as the first audio stream coming from the first direction;
generating, based on the at least one second direction, a second acoustic sound configured to be perceived as the at least one second audio stream coming from the at least one second direction; and
blending the first acoustic sound and the second acoustic sound into a third acoustic sound to be presented to a listener.

2. The method of claim 1, wherein the first audio stream includes at least one of the following: a music signal and a speech signal.

3. The method of claim 1, wherein the third acoustic sound is presented to the listener via a noise-isolating headset.

4. The method of claim 3, wherein the at least one second audio stream is generated based on an external acoustic sound captured outside the noise-isolating headset.

5. The method of claim 3, wherein the external acoustic sound is a ring tone from a cell phone.

6. The method of claim 3, wherein the external acoustic sound is a voice.

7. The method of claim 3, wherein the external acoustic sound is detected using auditory scene analysis.

8. The method of claim 1, wherein the first acoustic sound, configured to be perceived as the first audio stream coming from the first direction, and the at least one second acoustic sound, configured to be perceived as the at least one second audio stream coming from the at least one second direction, are monaural signals.

9. The method of claim 8, wherein the first acoustic sound, configured to be perceived as the first audio stream coming from the first direction, is directed to a first ear of the listener and the at least one second acoustic sound, configured to be perceived as the at least one second audio stream coming from the at least one second direction, is directed to a second ear of the listener.

10. The method of claim 1, wherein the first acoustic sound, configured to be perceived as the first audio stream coming from the first direction, and the at least one second acoustic sound, configured to be perceived as the at least one second audio stream coming from the at least one second direction, are binaural signals each perceived as coming from a different direction.

11. The method of claim 1, wherein:
the generating of the first acoustic sound includes modifying the first audio stream by a first head-related transfer function (HRTF) associated with the first direction; and
the generating of the at least one second acoustic sound includes modifying the at least one second audio stream by a second HRTF associated with the at least one second direction.

12. The method of claim 1, further comprising, prior to blending:
adding a first reverberation effect to the first acoustic sound to create a first depth perception; and
adding a second reverberation effect to the at least one second acoustic sound to create a second depth perception.

13. The method of claim 1, wherein the at least one second audio stream comprises three second audio streams, the first audio stream is set at 22.5 degrees to the user's left and one of the at least one second audio streams is set at 67.5 degrees to the user's right.

14. The method of claim 1, wherein the at least one second audio stream comprises three second audio streams, the first audio stream and the three second audio streams being set respectively at 67.5 degrees to the user's left, 22.5 degrees to the user's left, 22.5 degrees to the user's right, and 67.5 degrees to the user's right.

15. A system for binaural presentation of multiple audio streams, the system comprising:
a processor; and
a memory communicatively coupled with the processor, the memory storing instructions which, when executed by the processor, perform a method comprising:
receiving a first audio stream and at least one second audio stream;
associating the first audio stream with a first direction and the at least one second audio stream with at least one second direction, the at least one second direction being set at a predetermined non-zero angle with respect to the first direction;
generating, based on the first direction, a first acoustic sound configured to be perceived as the first audio stream coming from the first direction;
generating, based on the at least one second direction, at least one second acoustic sound configured to be perceived as the at least one second audio stream coming from the at least one second direction; and
blending the first acoustic sound and the at least one second acoustic sound into a third acoustic sound to be presented to a listener.

16. The system of claim 15, wherein the first audio stream includes at least one of the following: a music signal and a speech signal.

17. The system of claim 15, wherein the third acoustic sound is presented to the listener via a noise-isolating headset.

18. The system of claim 17, wherein the at least one second audio stream is generated based on an external acoustic sound captured outside the noise-isolating headset.

19. The system of claim 18, wherein the external acoustic sound is a voice or a ring tone.

20. The system of claim 18, wherein the external acoustic sound is detected using auditory scene analysis.

21. The system of claim 15, wherein:
the first acoustic sound, configured to be perceived as the first audio stream coming from the first direction, and the at least one second acoustic sound, configured to be perceived as the at least one second audio stream coming from the at least one second direction, are monaural signals; and
the first acoustic sound, configured to be perceived as the first audio stream coming from the first direction, is directed to a first ear of the listener and the at least one second acoustic sound, configured to be perceived as the at least one second audio stream coming from the at least one second direction, is directed to a second ear of the listener.

22. The system of claim 15, wherein the first acoustic sound, configured to be perceived as the first audio stream coming from the first direction, and the at least one second acoustic sound, configured to be perceived as the at least one second audio stream coming from the at least one second direction, are binaural signals each perceived as coming from a different direction.

23. The system of claim 15, wherein:
the generating of the first acoustic sound includes modifying the first audio stream by a first head-related transfer function (HRTF) associated with the first direction; and
the generating of the at least one second acoustic sound includes modifying the at least one second audio stream by a second HRTF associated with the at least one second direction.

24. The system of claim 15, further comprising, prior to blending:
adding a first reverberation effect to the first acoustic sound to create a first depth perception; and
adding a second reverberation effect to the at least one second acoustic sound to create a second depth perception.

25. A non-transitory computer-readable storage medium having embodied thereon instructions, which, when executed by at least one processor, perform steps of a method, the method comprising:
receiving a first audio stream and at least one second audio stream;
associating the first audio stream with a first direction and the at least one second audio stream with at least one second direction, the at least one second direction being set at a predetermined non-zero angle with respect to the first direction;
generating, based on the first direction, a first acoustic sound configured to be perceived as the first audio stream coming from the first direction;
generating, based on the at least one second direction, a second acoustic sound configured to be perceived as the at least one second audio stream coming from the at least one second direction; and
blending the first acoustic sound and the second acoustic sound into a third acoustic sound to be presented to a listener.
